(19) United States
(12) Patent Application Publication
(10) Pub. No.: US 2015/0363835 A1
(43) Pub. Date: Dec. 17, 2015

(54) UTILIZING HEURISTIC BIDDING TO DETERMINE INVENTORY BID LANDSCAPE OF AN ACTIVE REAL-TIME DISPLAY CAMPAIGN

(71) Applicant: GOOGLE INC., Mountain View, CA (US)

(72) Inventors: Mohammad Roshan Ali Khan, Mountain View, CA (US); Matthew Campbell Cary, Mountain View, CA (US); Saptarshi Bhattacharya, Mountain View, CA (US); Ekaterina Rogers, Mountain View, CA (US)

(73) Assignee: GOOGLE INC., Mountain View, CA (US)

(21) Appl. No.: 14/156,688

(22) Filed: Jan. 16, 2014

(51) Int. Cl. G06Q 30/02

(52) U.S. Cl. CPC G06Q 30/0275

(57) ABSTRACT

Systems and methods for determining a bid landscape for a content placement campaign are provided. A system identifies, for a content placement provider, serving parameters that define an inventory of content serving opportunities. The system creates bid buckets that have bid ranges. The system identifies a portion of the inventory to participate in bid discovery. The system selects, for each opportunity identified to participate, a bid value from within a bid bucket of the bid buckets. The bid value is provided as a bid for an auction to serve content in the opportunity. The system stores, for each of the identified content serving opportunities, the selected bid value and a result of the auction in which the selected bid value was provided as a bid. The system then determines an impression rate for each identified bid bucket and generates, from the determined impression rates, a bid landscape for the inventory.

### BACKGROUND

Third-party content providers can establish third-party content placement campaigns for providing one or more creatives for display. Typically, a third-party content provider will place bids on an inventory of impressions that meet serving parameters of the third-party content provider to serve creatives. The third-party content provider can achieve a higher impression rate by increasing the bid value of the bids placed on the inventory. Conversely, the third-party content provider can reduce the impression rate by decreasing the bid value of the bids placed on the inventory.

### SUMMARY

At least one aspect is directed to a method for determining a bid landscape for a content placement campaign is described. A data processing system identifies, for a content placement provider, one or more serving parameters that define an inventory of content serving opportunities. The data processing system creates a plurality of bid buckets. Each of the bid buckets has an associated bid value and a bid range that extends from a beginning bid boundary and an end bid boundary. The data processing system identifies a portion of the inventory of content serving opportunities to participate in bid discovery. The data processing system selects, for each content serving opportunity identified to participate in bid discovery, a bid value from within a bid bucket of the plurality of bid buckets. The selected bid value is provided as a bid for an auction to serve content in the content serving opportunity. The data processing system stores in a data store, for each of the content serving opportunities identified to participate in bid discovery, the selected bid value and a result of the auction in which the selected bid value was provided as a bid. The data processing system then identifies, from the data store, for each of the identified bid buckets, a first number of auctions in which a bid value from within a bid bucket was selected as a winning bid and a second number of auctions in which a bid value from within the bid bucket was selected to provide a bid. The data processing system then determines, from the data store, for each of the identified bid buckets, an impression rate corresponding to a ratio of the first number of auctions to the second number of auctions and generates, from the determined impression rates, a bid landscape for the inventory based on the determined impression rates.

In some implementations, the data processing system can select a bid value from within a bid bucket of the plurality of bid buckets by randomly selecting a bid value from within a bid bucket of the plurality of bid buckets.

In some implementations, the data processing system can create a plurality of bid buckets by determining a number of bid buckets across which to generate the bid landscape. In some implementations, the data processing system can create a plurality of bid buckets by determining a maximum bid value for placing as a bid in bid discovery, determining a number of bid buckets across which to generate the bid landscape and determining a bid range for each of the bid buckets.

In some implementations, each bid bucket has an associated bucket width identified as a difference between the end bid boundary and the beginning bid boundary of the associated bid bucket. The bucket width of a bid bucket is a function of a bid value of with the bid bucket.

In some implementations, each bid bucket has an associated bucket width identified as a difference between the end bid boundary and the beginning bid boundary of the associated bid bucket. In some such implementations, the bucket width of a bid bucket is a function of the bid value associated with the bid bucket.

In some implementations, the data processing system can receive, for the content placement provider, a request to participate in an auction to serve content in a content serving opportunity. The data processing system can determine that the content serving opportunity of the request matches the serving parameters of the content placement provider. The data processing system determines that the content serving opportunity of the request is a content serving opportunity identified to participate in bid discovery. The data processing system selects, from the plurality of bid buckets, a bid bucket according to which to bid for the content serving opportunity. The data processing system then provides, in the auction to serve content, a bid value from within the selected bid bucket as a bid for the content serving opportunity. The data processing system determines that the bid was one of a winning bid or a losing bid. The data processing system then increases a winning bid counter of the selected bid bucket responsive to determining that the bid was a winning bid. The data processing system also increases a total bid counter of the selected bid bucket responsive to determining that the bid was one of a winning bid or a losing bid. The data processing system then updates an impression conversion rate of the selected bid bucket.

In some implementations, the data processing system can select, from the plurality of bid buckets, a bid bucket according to which to bid for the content serving opportunity by selecting a bid bucket using a bid selection policy that includes one or more bid selection rules. The bid selection rules are based on one or more of impression-specific data or a total bid counter of the selected bid bucket identifying a total number of bids placed from within the selected bid bucket.

In some implementations, the data processing system can determine, from the determined impression rates, a marginal change in impression rates for each of the plurality of bid buckets. The marginal change in impression rates identifies a difference in an impression rate of a subject bid bucket having an associated bid value and an adjacent bid bucket having an associated bid value that is smaller than the associated bid value of the subject bid bucket. The data processing system can then determine, from the associated bid values of the plurality of bid buckets, a marginal change in bid values for each of the plurality of bid buckets. The marginal change in bid values identifies a difference in a bid value of the subject bid bucket and an associated bid value of the adjacent bid bucket. The data processing system can then determine, for each bid bucket, an impression cost ratio corresponding to a ratio of the determined marginal change in impression rates to the determined marginal change in bid values. The data processing system can identify the bid bucket having the highest impression cost ratio and can set the associated bid value of the identified bid bucket having the highest impression cost ratio as the desired bid value for balancing impressions received with cost.

Another aspect is directed to a system for determining a bid landscape for a content placement campaign is described. The system includes a data processing system that has a bid bucket creation module and a bid landscape determination module. The data processing system can include a memory storing processor-executable instructions and a processor configured to execute the processor executable instructions. In some implementations, the processor identifies, for a content placement provider, one or more serving parameters that define an inventory of content serving opportunities. The processor creates a plurality of bid buckets. Each of the bid buckets has an associated bid value and a bid range that extends from a beginning bid boundary and an end bid boundary. The processor identifies a portion of the inventory of content serving opportunities to participate in bid discovery. The processor selects, for each content serving opportunity identified to participate in bid discovery, a bid value from within a bid bucket of the plurality of bid buckets. The selected bid value is provided as a bid for an auction to serve content in the content serving opportunity. The processor stores in a data store, for each of the content serving opportunities identified to participate in bid discovery, the selected bid value and a result of the auction in which the selected bid value was provided as a bid. The processor then identifies, from the data store, for each of the identified bid buckets, a first number of auctions in which a bid value from within a bid bucket was selected as a winning bid and a second number of auctions in which a bid value from within the bid bucket was selected to provide a bid. The processor then determines, from the data store, for each of the identified bid buckets, an impression rate corresponding to a ratio of the first number of auctions to the second number of auctions and generates, from the determined impression rates, a bid landscape for the inventory based on the determined impression rates.

In some implementations, the processor can select a bid value from within a bid bucket of the plurality of bid buckets by randomly selecting a bid value from within a bid bucket of the plurality of bid buckets.

In some implementations, the processor can create a plurality of bid buckets by determining a number of bid buckets across which to generate the bid landscape. In some implementations, the processor can create a plurality of bid buckets by determining a maximum bid value for placing as a bid in bid discovery, determining a number of bid buckets across which to generate the bid landscape and determining a bid range for each of the bid buckets.

In some implementations, each bid bucket has an associated bucket width identified as a difference between the end bid boundary and the beginning bid boundary of the associated bid bucket. The bucket width of a bid bucket is a function of a bid value of with the bid bucket.

In some implementations, the processor can receive, for the content placement provider, a request to participate in an auction to serve content in a content serving opportunity. The processor can determine that the content serving opportunity of the request matches the serving parameters of the content placement provider. The processor determines that the content serving opportunity of the request is a content serving opportunity identified to participate in bid discovery. The processor selects, from the plurality of bid buckets, a bid bucket according to which to bid for the content serving opportunity. The processor then provides, in the auction to serve content, a bid value from within the selected bid bucket as a bid for the content serving opportunity. The processor determines that the bid was one of a winning bid or a losing bid. The processor then increases a winning bid counter of the selected bid bucket responsive to determining that the bid was a winning bid. The processor also increases a total bid counter of the selected bid bucket responsive to determining that the bid was one of a winning bid or a losing bid. The processor then updates an impression conversion rate of the selected bid bucket.

In some implementations, the processor can select, from the plurality of bid buckets, a bid bucket according to which to bid for the content serving opportunity by selecting a bid bucket using a bid selection policy that includes one or more bid selection rules. The bid selection rules are based on one or more of impression-specific data or a total bid counter of the selected bid bucket identifying a total number of bids placed from within the selected bid bucket.

In some implementations, the processor can determine, from the determined impression rates, a marginal change in impression rates for each of the plurality of bid buckets. The marginal change in impression rates identifies a difference in an impression rate of a subject bid bucket having an associated bid value and an adjacent bid bucket having an associated bid value that is smaller than the associated bid value of the subject bid bucket. The processor can then determine, from the associated bid values of the plurality of bid buckets, a marginal change in bid values for each of the plurality of bid buckets. The marginal change in bid values identifies a difference in a bid value of the subject bid bucket and an associated bid value of the adjacent bid bucket. The processor can then determine, for each bid bucket, an impression cost ratio corresponding to a ratio of the determined marginal change in impression rates to the determined marginal change in bid values. The processor can identify the bid bucket having the highest impression cost ratio and can set the associated bid value of the identified bid bucket having the highest impression cost ratio as the desired bid value for balancing impressions received with cost.

Another aspect is directed to a computer-readable medium having instructions to provide information via a computer network. The instructions include instructions that cause a processor to identify, for a content placement provider, one or more serving parameters that define an inventory of content serving opportunities. The processor creates a plurality of bid buckets. Each of the bid buckets has an associated bid value and a bid range that extends from a beginning bid boundary and an end bid boundary. The processor identifies a portion of the inventory of content serving opportunities to participate in bid discovery. The processor selects, for each content serving opportunity identified to participate in bid discovery, a bid value from within a bid bucket of the plurality of bid buckets. The selected bid value is provided as a bid for an auction to serve content in the content serving opportunity. The processor stores in a data store, for each of the content serving opportunities identified to participate in bid discovery, the selected bid value and a result of the auction in which the selected bid value was provided as a bid. The processor then identifies, from the data store, for each of the identified bid buckets, a first number of auctions in which a bid value from within a bid bucket was selected as a winning bid and a second number of auctions in which a bid value from within the bid bucket was selected to provide a bid. The processor then determines, from the data store, for each of the identified bid buckets, an impression rate corresponding to a ratio of the first number of auctions to the second number of auctions and generates, from the determined impression rates, a bid landscape for the inventory based on the determined impression rates.

In some implementations, the processor can select a bid value from within a bid bucket of the plurality of bid buckets by randomly selecting a bid value from within a bid bucket of the plurality of bid buckets.

In some implementations, the processor can create a plurality of bid buckets by determining a number of bid buckets across which to generate the bid landscape. In some implementations, the processor can create a plurality of bid buckets by determining a maximum bid value for placing as a bid in bid discovery, determining a number of bid buckets across which to generate the bid landscape and determining a bid range for each of the bid buckets.

In some implementations, each bid bucket has an associated bucket width identified as a difference between the end bid boundary and the beginning bid boundary of the associated bid bucket. In some such implementations, the bucket width of a bid bucket is a function of the bid value associated with the bid bucket.

In some implementations, the processor can receive, for the content placement provider, a request to participate in an auction to serve content in a content serving opportunity. The processor can determine that the content serving opportunity of the request matches the serving parameters of the content placement provider. The processor determines that the content serving opportunity of the request is a content serving opportunity identified to participate in bid discovery. The processor selects, from the plurality of bid buckets, a bid bucket according to which to bid for the content serving opportunity. The processor then provides, in the auction to serve content, a bid value from within the selected bid bucket as a bid for the content serving opportunity. The processor determines that the bid was one of a winning bid or a losing bid. The processor then increases a winning bid counter of the selected bid bucket responsive to determining that the bid was a winning bid. The processor also increases a total bid counter of the selected bid bucket responsive to determining that the bid was one of a winning bid or a losing bid. The processor then updates an impression conversion rate of the selected bid bucket.

In some implementations, the processor can select, from the plurality of bid buckets, a bid bucket according to which to bid for the content serving opportunity by selecting a bid bucket using a bid selection policy that includes one or more bid selection rules. The bid selection rules are based on one or more of impression-specific data or a total bid counter of the selected bid bucket identifying a total number of bids placed from within the selected bid bucket.

In some implementations, the processor can determine, from the determined impression rates, a marginal change in impression rates for each of the plurality of bid buckets. The marginal change in impression rates identifies a difference in an impression rate of a subject bid bucket having an associated bid value and an adjacent bid bucket having an associated bid value that is smaller than the associated bid value of the subject bid bucket. The processor can then determine, from the associated bid values of the plurality of bid buckets, a marginal change in bid values for each of the plurality of bid buckets. The marginal change in bid values identifies a difference in a bid value of the subject bid bucket and an associated bid value of the adjacent bid bucket. The processor can then determine, for each bid bucket, an impression cost ratio corresponding to a ratio of the determined marginal change in impression rates to the determined marginal change in bid values. The processor can identify the bid bucket having the highest impression cost ratio and can set the associated bid value of the identified bid bucket having the highest impression cost ratio as the desired bid value for balancing impressions received with cost.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 is a block diagram depicting one implementation of an environment for determining a bid landscape for a content placement campaign, according to an illustrative implementation;

FIG. 2 is a graphical representation of impression volume across a range of bid values;

FIG. 3 is a screenshot of impression rate over a range of bid values; and

FIG. 4 is a flow diagram depicting one implementation of the steps taken to identify;

FIG. 4 is a flow diagram depicting one implementation of the steps taken to determine a bid landscape for a content placement campaign; and

FIG. 5 is a block diagram illustrating an implementation of a general architecture for a computer system that may be employed to implement various elements of the systems and methods described and illustrated herein.

### DETAILED DESCRIPTION

Following below are more detailed descriptions of various concepts related to, and implementations of methods, apparatuses, and systems for determining a bid landscape for a content placement campaign. The various concepts introduced above and discussed in greater detail below may be implemented in any of numerous ways, as the described concepts are not limited to any particular manner of implementation. Examples of specific implementations and applications are provided primarily for illustrative purposes.

Third-party content providers, such as advertisers, can establish one or more advertising campaigns for providing creatives for display. In some implementations, advertisers can participate in auctions by placing bids on opportunities to display creatives. An advertising campaign can include one or more serving parameters. These serving parameters can define opportunities for which the advertiser would like to serve ads. For instance, the serving parameters may include, for example, one or more of the following: features of (including information on) a document on which, or with which, the ad is to be served, a search query or search results associated with the serving of the ad, characteristics associated with the device on which to serve the ad (e.g., the device's geographic location, the language in which to present the ad, the browser type, etc.), an absolute position of the ad on the page on which it was served, a position of the ad slot within which to serve the ad relative to other ad slot positions, an absolute size of the ad, temporal characteristics associated with the opportunity (e.g., time of day the ad is served, time of week the ad is served, time of year served, etc.) Naturally, there are other serving parameters that may be used in the context of the invention.

The opportunities for which the advertiser would like to serve ads can be referred to as the inventory. Typically, to serve a creative for an opportunity, an advertiser will place bids on the inventory of impressions that meet the serving parameters of the advertiser. Generally, the higher the value of the placed bid, the greater the likelihood that the advertiser will win the opportunity to serve the creative.

Although the advertiser may wish to win each and every opportunity to serve creative, the advertiser is working off of a limited budget. As such, one of the challenges an advertiser faces when participating in auctions for serving creatives is being able to set a bid value that is high enough to win a desired percentage of the inventory of impressions that meet the serving parameters of the advertiser, yet low enough that the advertiser is not paying too much for the impressions the advertiser wins.

As an example, an advertiser currently has set a bid value to be $1 for the inventory of impressions that meet the serving parameters of the advertiser. At a bid value of $1, the advertiser realizes that his impression rate is 40%. That is, for every ten impressions that he bids on, he wins only 4 of them. The advertiser currently has no way of knowing an amount by which to increase the bid value to realize an impression rate of 70%. At present, in order for the advertiser to know the bid value that will realize an impression rate of 70%, the advertiser employs a lot of guesswork and using trial and error may attempt to identify the bid value that corresponds to an impression rate of 70%. For example, the advertiser may arbitrarily increase the bid value to $1.50 only to realize a week later that the impression rate is 85%. The advertiser then arbitrarily decreases the bid value to $1.25 to realize that the impression rate is now 55%. The advertiser repeatedly increases and decreases the bid values until he finally determines that a bid value of $1.30 realizes an impression rate of 70%. This manual process of adjusting bid values requires a lot of human input and monitoring and can take a while to test the various bid values.

The present disclosure relates to methods and systems for utilizing heuristic bidding to determine an inventory bid landscape of an active real-time third-party content campaign. In particular, a data processing system identifies, for a content placement provider, one or more serving parameters that define an inventory of content serving opportunities. The data processing system creates a plurality of bid buckets. Each of the bid buckets has an associated bid value and a bid range that extends from a beginning bid boundary and an end bid boundary. The data processing system identifies a portion of the inventory of content serving opportunities to participate in bid discovery. The data processing system selects, for each content serving opportunity identified to participate in bid discovery, a bid value from within a bid bucket of the plurality of bid buckets. The selected bid value is provided as a bid for an auction to serve content in the content serving opportunity. The data processing system stores in a data store, for each of the content serving opportunities identified to participate in bid discovery, the selected bid value and a result of the auction in which the selected bid value was provided as a bid. The data processing system then identifies, from the data store, for each of the identified bid buckets, a first number of auctions in which a bid value from within a bid bucket was selected as a winning bid and a second number of auctions in which a bid value from within the bid bucket was selected to provide a bid. The data processing system then determines, from the data store, for each of the identified bid buckets, an impression rate corresponding to a ratio of the first number of auctions to the second number of auctions and generates, from the determined impression rates, a bid landscape for the inventory based on the determined impression rates.

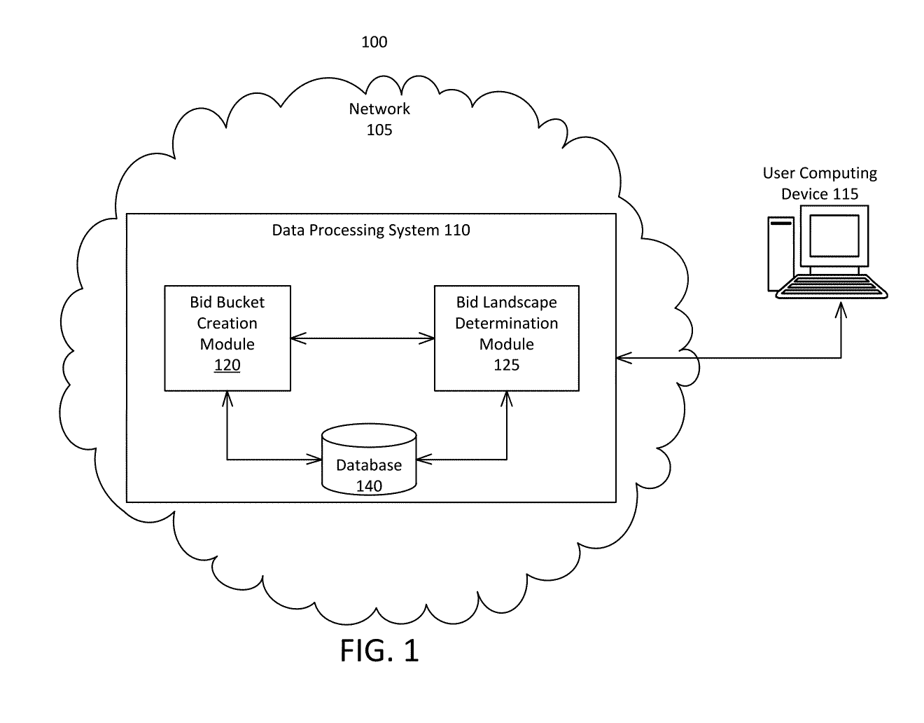

FIG. 1 is a block diagram depicting one implementation of an environment for determining a bid landscape for a content placement campaign. In particular, FIG. 1 illustrates a system 100 for utilizing heuristic bidding to determine inventory bid landscape of an active real-time display campaign. The system 100 includes at least one data processing system 110. The data processing system 110 can include at least one processor and a memory, i.e., a processing circuit. The memory stores processor-executable instructions that, when executed by processor, cause the processor to perform one or more of the operations described herein. The processor may include a microprocessor, application-specific integrated circuit (ASIC), field-programmable gate array (FPGA), etc., or combinations thereof The memory may include, but is not limited to, electronic, optical, magnetic, or any other storage or transmission device capable of providing the processor with program instructions. The memory may further include a floppy disk, CD-ROM, DVD, magnetic disk, memory chip, ASIC, FPGA, read-only memory (ROM), random-access memory (RAM), electrically-erasable ROM (EEPROM), erasable-programmable ROM (EPROM), flash memory, optical media, or any other suitable memory from which the processor can read instructions. The instructions may include code from any suitable computer-programming language such as, but not limited to, C, C++, C#, Java, JavaScript, Perl, Python and Visual Basic. The data processing system can include one or more computing devices or servers that can perform various functions. In some implementations, the data processing system can include an advertising auction system configured to host auctions. In some implementations, the data processing system does not include the advertising auction system but is configured to communicate with the advertising auction system via the network 105. The data processing system 110 can include one or more processors or other logic devices such as a computing device having a processor to communicate via a network 105 with at least one user computing device 115. In some implementations, the user computing device 115 and the data processing system 110 can communicate with one another via the network 105.

The network 105 may be any form of computer network that relays information between the user computing device 115, data processing system 110, and one or more content sources, for example, web servers, advertising servers, amongst others. For example, the network 105 may include the Internet and/or other types of data networks, such as a local area network (LAN), a wide area network (WAN), a cellular network, satellite network, or other types of data networks. The network 105 may also include any number of computing devices (e.g., computer, servers, routers, network switches, etc.) that are configured to receive and/or transmit data within network 105. The network 105 may further include any number of hardwired and/or wireless connections. For example, the user computing device 115 may communicate wirelessly (e.g., via WiFi, cellular, radio, etc.) with a transceiver that is hardwired (e.g., via a fiber optic cable, a CATS cable, etc.) to other computing devices in network 105.

The user computing device 115 may be any number of different user electronic devices, for example, a laptop computer, a desktop computer, a tablet computer, a smartphone, a digital video recorder, a set-top box for a television, a video game console, or any other computing device configured to communicate via the network 105. The user computing device 115 can include a processor and a memory, i.e., a processing circuit. The memory stores machine instructions that, when executed by processor, cause processor to perform one or more of the operations described herein. The processor may include a microprocessor, application-specific integrated circuit (ASIC), field-programmable gate array (FPGA), etc., or combinations thereof. The memory may include, but is not limited to, electronic, optical, magnetic, or any other storage or transmission device capable of providing the processor with program instructions. The memory may further include a floppy disk, CD-ROM, DVD, magnetic disk, memory chip, ASIC, FPGA, read-only memory (ROM), random-access memory (RAM), electrically-erasable ROM (EEPROM), erasable-programmable ROM (EPROM), flash memory, optical media, or any other suitable memory from which the processor can read instructions. The instructions may include code from any suitable computer-programming language such as, but not limited to, C, C++, C#, Java, JavaScript, Perl, Python and Visual Basic.

The user computing device 115 may also include one or more user interface devices. In general, a user interface device refers to any electronic device that conveys data to a user by generating sensory information (e.g., a visualization on a display, one or more sounds, etc.) and/or converts received sensory information from a user into electronic signals (e.g., a keyboard, a mouse, a pointing device, a touch screen display, a microphone, etc.). The one or more user interface devices may be internal to a housing of the user computing device 115 (e.g., a built-in display, microphone, etc.) or external to the housing of the user computing device 115 (e.g., a monitor connected to the user computing device 115, a speaker connected to the user computing device 115, etc.), according to various implementations. For example, the user computing device 115 may include an electronic display, which visually displays web pages using webpage data received from one or more content sources and/or from the data processing system 110 via the network 105. In some implementations, a content placement campaign manager or advertiser can communicate with the data processing system 110 via the user computing device 115. In some implementations, the advertiser can communicate with the data processing system 110 via a user interface displayed on the user interface devices of the user computing device 115. In some implementations, the user computing device 115 can be configured to allow an advertiser to manage one or more ad campaigns by interacting with the data processing system 110. In some implementations, the advertiser can view the results of the data processing system 110, including but not limited to, one or more bid landscapes associated with ad campaigns of the advertiser.

The data processing system 110 can include at least one server. In some implementations, the data processing system 110 includes a bid bucket creation module 120 and a bid landscape determination module 125. The data processing system can also include one or more content repositories or databases 140.

The bid bucket creation module 120 can be designed, constructed or configured to create bid buckets to provide bids for determining bid landscape. The bid bucket creation module 120 can be configured to receive, from an advertiser, a request to participate in bid discovery. Bid discovery is a process in which bids of different bid values are placed in auctions to determine the bid landscape for an inventory of content serving opportunities.

The bid bucket creation module 120 can identify, for an advertising campaign of an advertiser, one or more serving parameters that define an inventory of content serving opportunities that meet the serving parameters of the advertiser. In some implementations, the bid bucket creation module 120 can identify the one or more serving parameters that define an inventory of content serving opportunities by receiving the one or more serving parameters from the content placement provider. The serving parameters of the advertiser can include conditions on the types of content serving opportunities for which to place a bid in an auction to serve content. For example, if the advertiser is a tennis retailer, the advertiser can set one or more serving parameters to provide advertisements on sports related websites. The inventory of content serving opportunities includes all content serving opportunities for which the advertiser can place a bid in an auction to serve the advertiser's content. In this way, whenever an auction for a content serving opportunity that meets the advertiser's serving parameters occurs, the advertiser can place a bid for the content serving opportunity. In some implementations, the serving parameters of the advertiser are provided by the advertiser. In some implementations, the serving parameters of the advertiser can include limitations based on search query terms, user types, device types, time of day, day of week, geographical location of the device to which the content is to be served, amongst others.

The bid bucket creation module 120 can create a plurality of bid buckets. In some implementations, the bid bucket creation module 120 can be configured to first determine a range of bid values over which to determine a bid landscape. For example, the bounds of the range of bid values can be based on a bid value specified by the advertiser. In some implementations, the bounds of the range of bid values can extend from 10% of the bid value specified by the advertiser to 16 times the bid value specified by the advertiser. In some implementations, the bounds can be based on an analysis of historical bid values for content serving opportunities that meet the serving parameters of the advertiser's content placement campaign. In some such implementations, the range of the bid values can extend from 10% of an average of the historical bid values to 16 times the average. In some implementations, a lower bound of the range of bid values can be anywhere from 1%-90% of the bid value used to calculate the range of bid values, while a higher bound of the range of bid values can be anywhere from 1.5 times to 50 times the bid value used to calculate the range of bid values.

It should be appreciated that selecting a very high higher bound of the range may result in the advertiser having to pay more for bids and as such, there may be dollar amount cap on a bid regardless of the bid value used to calculate the upper bound of the range of bid values. For example, the upper bound of the range of bid values may not exceed $10 dollars a bid. Conversely, it may be undesirable to place bids that are too small as the likelihood of winning an auction is very low, thereby wasting a content serving opportunity while not learning much about the bid landscape. In some implementations, the lower range of bid values can be determined by determining the lowest bid value that has won an auction in previous content serving opportunities. In some implementations, the lower bound may be set to a fixed dollar amount, for example, $0.01. In some implementations, the bid values are based on cost per thousand impressions (CPM), or some other bid pricing scheme, such as cost per click, cost per action, amongst others.

The bid bucket creation module 120 can then create one or more bid buckets spanning the range of bid values over which to determine a bid landscape. As described above, the range of bid values over which to determine a bid landscape can have a lower bound and an upper bound. In some implementations, the bid bucket creation module 120 can determine a number of bid buckets to create. In some implementations, the number of bid buckets to create can be provided by the advertiser. In some implementations, the bid bucket creation module 120 can determine a number of bid buckets across which to determine the bid landscape based on the range of bid values over which to determine a bid landscape. In some implementations, the bid bucket creation module 120 can determine the number of bid buckets to create based on bid values of auctions previously conducted. For example, the bid bucket creation module 120 can analyze a set of auctions for serving content in a plurality of content serving opportunities that meet the serving parameters of the advertiser's content placement campaign. If the range of winning bid values across the set of auctions is large, the number of bid buckets may also be large. Conversely, if the range of winning bid values across the set of auctions is small, the number of bid buckets may also be small. In general, the granularity of the bid landscape can depend on the number of bid buckets created. The greater the number of bid buckets, the more granular the results of the bid landscape will be.

The bid bucket creation module 120 can be configured to also determine a bid range extending between a beginning bid boundary and an end bid boundary. The beginning bid boundary can be a lower bound of the bid bucket and the end bid boundary can be an upper bound of the bid bucket. The bid width of the bid bucket is the difference between the end bid boundary and the beginning bid boundary. The plurality of bid buckets are sequentially created or arranged such that the first bid bucket has a beginning bid boundary that is equal to the lower bound of the range of bid values over which to determine the bid landscape and a last bid bucket has an end bid boundary that is equal to the upper bound of the range of bid values over which to determine the bid landscape. Moreover, in some implementations, other bid buckets not including the first and last bid buckets have a beginning bid boundary that is adjacent to an adjacent bid bucket's end bid boundary and an end bid boundary that is adjacent to another bid buckets beginning bid boundary. In this way, the bid buckets, collectively, cover all bid values extending between the lower bound and the upper bound of the range of bid values over which to determine the bid landscape. By way of example, the first bid bucket can extend from $0.01 to $0.1, the second bid bucket can extend from $0.101 to $0.2, the third bid bucket can extend from $0.201 to $0.3, and so forth, until the last bid bucket extends from a beginning bid value to say, $10 (which in this example, is the upper bound of the range of bid values across which to determine bid landscapes). In this particular example, the bid width across each of the plurality of bid buckets is the same or uniform (the bid width was 0.99). In some other implementations, the bid bucket creation module 120 can create bid buckets that are separated by gaps. For example, the first bid bucket can extend from $0.01 to $0.2, the second bid bucket can extend from $0.4 to $0.8, the third bid bucket can extend from $1.2 to $3, and so forth, until the last bid bucket extends from a beginning bid value to say, $10 (which is also the upper bound of the range of bid values across which to determine bid landscapes in this example). In this example, the bid widths of the bid buckets were not uniform or different.

The bid bucket creation module 120 can determine the bid widths for each of the bid buckets. In some implementations, the bid bucket creation module 120 can determine a uniform bid width for each of the bid buckets. In some implementations, the bid width can be determined by dividing the difference between the upper bound and the lower bound of the range of bid values over which to determine the bid landscape by the number of bid buckets to create. That is bid width=(upper bound−lower bound)/n, where upper bound is the upper bound of the range of bid values over which to determine the bid landscape, the lower bound is the lower bound of the range of bid values over which to determine the bid landscape and n is the number of bid buckets to create. When using cost per thousand impressions (CPM) as the bid value, the bid width=maximum (CPM−lowest CPM)/n.

In some implementations, the bid bucket creation module can set the bid widths for the plurality of bid buckets based on the average bid value of the bid bucket. For example, for all bid buckets having an average bid value between $0.01 and $1, the bid width can be $0.1, for all bid buckets having an average bid value between $1 and $5, the bid width can be $0.2, and for all bid buckets having an average bid value between $5 and $10, the bid width can be $0.5.

In some implementations, the bid bucket creation module can set the bid widths for the plurality of bid buckets according to an arithmetic progression. For example, each subsequent bid bucket can have a bid width that is a fixed percentage bigger than the bid width of a previous bid bucket. For example, the fixed percentage is 10%. If the first bid bucket extends between $0.01 and $0.1, the next bid bucket can extend from $0.11 to $0.21 and the subsequent bid bucket can extend from $0.22-$0.33, and the subsequent bid bucket can extend from $0.34-$0.46. The bid widths as shown are increasing from 0.09, 0.10, 0.11, 0.12, and so forth. Here, the increase was 0.01 per subsequent bid bucket. In some implementations, the increase can be anywhere between $0.01 and $2. In some implementations, the increase can be dependent on the average bid value of the bid bucket. For example, for all bid buckets having an average bid value of less than $1, the bid width increment between subsequent bid buckets is $0.1. For bid buckets bid buckets having an average bid value of between $1 and $5, the bid width increment between subsequent bid buckets is $0.2 such that the bid buckets are $1-$1.2, $1.2-1.6, $1.6-2.2, $2.2-$3, and so forth. For bid buckets bid buckets having an average bid value of between $5 and $10, the bid width increment between subsequent bid buckets is $0.5, such that the bid buckets are $5-$5.5, $5.5-$6.5, $6.5-$8, and $8-$10.

In some implementations, the bid bucket creation module can set the bid widths for the plurality of bid buckets according to a logarithmic or exponential scale. For example, each subsequent bid bucket can have a bid width that is a fixed percentage bigger than the bid width of a previous bid bucket. For example, the bid widths of subsequent bid buckets can increase by 10% of the bid width of the previous bid bucket. For example, the bid buckets created based on a logarithmic scale can be $0.01-$0.10, $0.10-$0.20, $0.20-$0.32, $0.32 to $0.45, and so forth.

The bid bucket creation module 120 can further be configured to dynamically adjust the bid buckets and their bid widths. The bid bucket creation module 120 can adjust these bid buckets based on the performance of bid values in one or more auctions. If bid values from a bid bucket are unable to win any auctions, the bid bucket creation module 120 may remove this bid bucket from participation in bid discovery. Moreover, if bid values of a bid bucket are winning every auction in which the bid value participates, the bid bucket creation module 120 may be configured to lower the lower and upper bounds of the bid bucket or remove the bid bucket so that bid values from the bid bucket are not provided in auctions.

The bid bucket creation module 120 can then identify a portion of the inventory of content serving opportunities for selection to participate in bid discovery. In some implementations, the advertiser can elect to participate in bid discovery. In some implementations, the advertiser can be presented with an option to have a particular content placement campaign of the advertiser participate in bid discovery. In some implementations, the advertiser can select a percentage of the inventory of content serving opportunities to use towards participating in bid discovery. For the remaining percentage of content serving opportunities, the data processing system 110 can use a bid value provided by the advertiser to compete in auctions for serving content in content serving opportunities. For example, if the advertiser elects to use 10% of the content serving opportunities for bid discovery, every tenth content serving opportunity may be used for bid discovery. For the remaining nine content serving opportunities, the bid value provided by the advertiser may be used. In some implementations, the content serving opportunities can be selected at random. In some such implementations, over a period of time, the number of content serving opportunities selected to participate in bid discovery relative to the total number of content serving opportunities may correspond to the percentage of content serving opportunities selected to participate in bid discovery. In some implementations, the data processing system 110 can automatically determine the number of content serving opportunities to use in bid discovery. In some implementations, the number of content serving opportunities can be based on a budget of the advertiser. In some implementations, the advertiser may allocate a separate budget for bid discovery. In some implementations, the advertiser may also provide a time frame within which to utilize the budget. In some implementations, the budget and the time frame can be used to determine the percentage or number of content serving opportunities to use for bid discovery.

Once the bid bucket creation module 120 has established bid buckets as described above, the process of bid discovery can begin. In bid discovery, the bid landscape determination module 125 is configured to determine a bid landscape for the advertiser's content placement campaign. The bid landscape allows an advertiser to get a sense of the number of content serving opportunities the advertiser will likely win if the advertiser sets a particular bid value. Moreover, the bid landscape can help determine a bid value to select to achieve a particular impression rate. In addition, the bid landscape can help determine a change in the number of auctions the advertiser is likely to win by changing the bid value from a first bid value to a second bid value.

The bid landscape determination module 125 can be configured to identify one or more content serving opportunities for selection to participate in bid discovery. In some implementations, the bid landscape determination module 125 can identify if a content serving opportunity meets the serving parameters of the content placement campaign of an advertiser. The content serving opportunities that meet the serving parameters form the inventory of content serving opportunities.

The bid landscape determination module 125 can apply an opportunity selection policy to select one or more content serving opportunities for bid discovery. The opportunity selection policy can include one or more rules for selecting, from the inventory of content serving opportunities, a content serving opportunity for bid discovery. In some implementations, the opportunity selection policy can be based on a size of a portion of the inventory of content serving opportunities identified to participate in bid discovery. In some implementations, if the size of the portion of the inventory is 10% of all content serving opportunities that meet the serving parameters, the opportunity selection policy can select every tenth content serving opportunity for bid discovery. In some implementations, the opportunity selection policy can select content serving opportunities at random while ensuring that the number of content serving opportunities does not exceed the size of the portion of the inventory identified for bid discovery.

Once a content serving opportunity that meets the serving parameters is selected for bid discovery, the bid landscape determination module 125 can be configured to select, from the plurality of bid buckets, a bid bucket according to which to bid for the content serving opportunity. In some implementations, the bid bucket can be selected at random. In some implementations, the bid bucket can be selected according to a predetermined sequence. Factors considered when selecting a bid bucket can include time of day, device type, user information associated with the device on which the content is to be served, amongst others. In some implementations, the bid landscape determination module 125 can select the bid bucket according to which to bid for the content serving opportunity by selecting a bid bucket using a bid selection policy that includes one or more bid selection rules. The bid selection rules are based on one or more of impression-specific data or a total bid counter of the selected bid bucket identifying a total number of bids placed from within the selected bid bucket. In some implementations, the bid landscape determination module 125 can monitor the total bid counters of each of the bid buckets and select a bid bucket from which to choose a bid value based on the relative counts of each of the total bid counters.

Once a bid bucket is selected, the bid landscape determination module 125 can be configured to determine a bid value of the selected bid bucket as a bid for the identified content serving opportunity. The bid value can be the average bid value of the bid bucket. In some implementations, the average bid value can be determined by dividing the sum of the beginning bid boundary and the end bid boundary of the bid bucket by two. In some implementations, the bid value can be any bid value between the beginning bid boundary and the end bid boundary. In some implementations, the bid value can be selected at random. Over time, the average bid value for the bid bucket can eventually average out to a bid value close to the sum of the beginning bid boundary and the end bid boundary of the bid bucket divided by two.

The bid landscape determination module 125 can be configured to use the selected bid value in an auction to serve content for the content serving opportunity. In some implementations, the bid landscape determination module 125 can provide the selected bid value to an advertising auction system that conducts auctions for serving content. In some implementations, the advertising auction system can be a part of the data processing system 110.

The bid landscape determination module 125 can be configured to then determine whether the selected bid was one of a winning bid or a losing bid. If the advertiser's selected bid resulted in a content item of the advertiser being served for the content serving opportunity, the bid landscape determination module 125 can determine that the selected bid is a winning bid. Conversely, if the advertiser's selected bid does not result in a content item of the advertiser being served for the content serving opportunity, the bid landscape determination module 125 can determine that the selected bid is a losing bid.

The bid landscape determination module 125 can be configured to store the selected bid value and a result of the auction in which the selected bid value was provided as a bid for each of the content serving opportunities identified to participate in bid discovery. In some implementations, the bid landscape determination module 125 can maintain one or more data stores or databases that store information about the content serving opportunities identified to participate in bid discovery. In some implementations, the database 140 of the data processing system 110 can include the data stores in which the information about the content serving opportunities identified to participate in bid discovery is stored.

The bid landscape determination module 125 can be configured to maintain various counters to keep track of the number of auctions the advertiser wins at a particular bid value. In some implementations, the bid landscape determination module 125 can be configured to increase a winning bid counter of the selected bid bucket responsive to determining that the bid was a winning bid. The bid landscape determination module 125 can increase a total bid counter of the selected bid bucket responsive to determining that the bid was one of a winning bid or a losing bid. Stated in another way, the bid landscape determination module can increase a total bid counter of the selected bid bucket each time a bid value that lies within the selected bid bucket is provided as a bid in an auction to serve content in the content serving opportunity. In some implementations, increasing a counter corresponds to incrementing the counter by 1.

In some implementations, once the bid landscape determination module 125 has provided bid values from the plurality of bid buckets in auctions for content serving opportunities, the bid landscape determination module 125 can begin calculating metrics for determining the bid landscape. In some implementations, the bid landscape determination module 125 can determine an impression rate for each of the identified bid buckets. The impression rate is the percentage of auctions in which bid values from within a bid bucket that result in a content item of the advertiser achieving an impression. The greater the impression rate, the more likely the advertiser is likely to win an auction and have an opportunity to serve content in the content serving opportunity.

To determine an impression rate for a bid bucket, the bid landscape determination module 125 can identify the total number of bid values selected from the bid bucket to be placed as bids in auctions for content serving opportunities. In some implementations, the bid landscape determination module 125 can identify the total number of bid values from the total bid counter of the corresponding bid bucket. The bid landscape determination module 125 can also be configured to determine a number of bid values from the total number of bid values that resulted in the advertiser serving content for the content serving opportunity. Stated in another way, the bid landscape determination module 125 can determine a number of winning bid values that resulted in the advertiser serving content for the content serving opportunity. In some implementations, the bid landscape determination module 125 can determine the number of winning bid values from the winning bid counter corresponding to the given bid bucket. The bid landscape determination module 125 can then divide the number of winning bid values by the total number of bid values to determine an impression rate for the given bid bucket. In some implementations, the bid landscape determination module 125 can periodically update the impression rate of each of the plurality of bid buckets. In some implementations, the bid landscape determination module 125 can update the impression rate of a bid bucket each time a bid value from the given bid bucket is provided in an auction. In some implementations, the bid landscape determination module 125 can update the impression rate of one or more bid buckets on a daily or weekly basis.

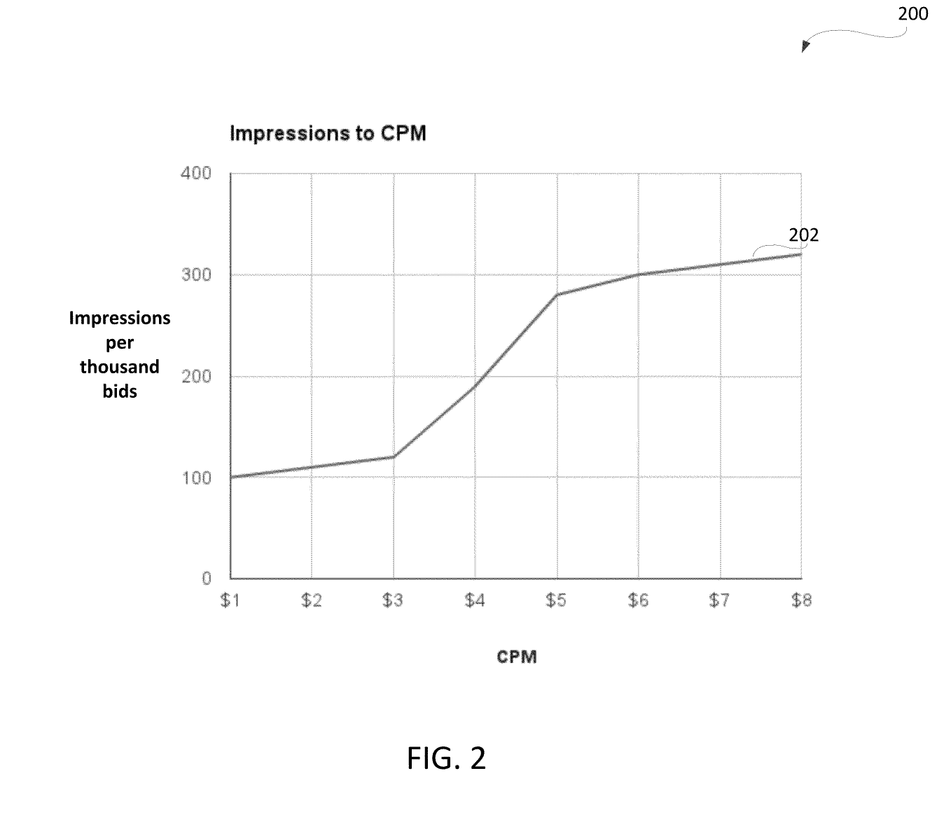

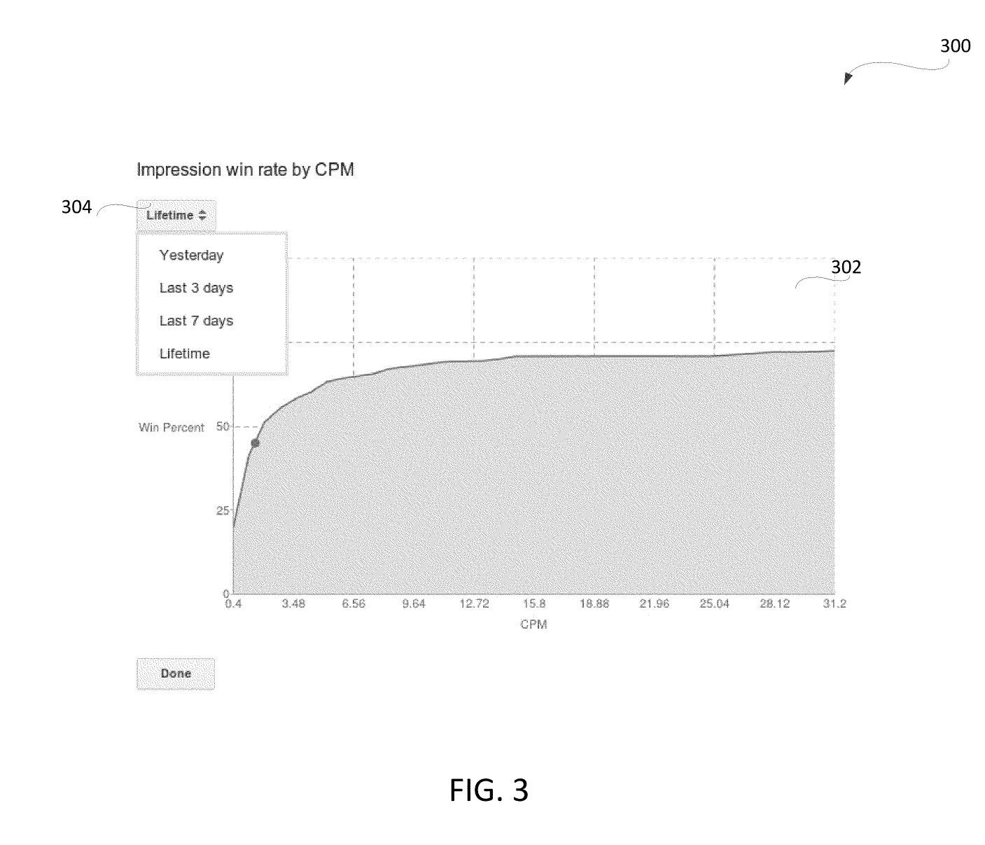

The bid landscape determination module 125 can be configured to generate, from the determined impression rates, a bid landscape for the inventory of content serving opportunities that meet the serving parameters of the advertiser's content placement campaign based on the determined impression rates. In some implementations, the bid landscape determination module 125 can present the impression rates of each of the bid buckets in a graphical representation, for example, as shown in FIGS. 2 and 3.

Once the bid landscape has been generated, the results can be utilized to determine a bid strategy for an advertiser. In some implementations, the bid landscape determination module or the data processing system 110 can determine, from the determined impression rates, a marginal change in impression rates for each of the plurality of bid buckets relative to a corresponding preceding bid buckets. The marginal change in impression rates identifies a difference in an impression rate of a subject bid bucket and an adjacent bid bucket having bid values that are smaller than the bid values of the subject bid bucket. The data processing system 110 can then determine, from the bid values of the plurality of bid buckets, a marginal change in bid values for each of the plurality of bid buckets relative to a corresponding preceding bid bucket. The marginal change in bid values identifies a difference in a bid value of the subject bid bucket and a corresponding bid value of the adjacent bid bucket. The data processing system 110 can then determine, for each bid bucket, an impression cost ratio corresponding to a ratio of the determined marginal change in impression rates to the determined marginal change in bid values. The data processing system 110 can then identify the bid bucket having the highest impression cost ratio and can choose a bid value from the identified bid bucket having the highest impression cost ratio as the desired bid value for balancing impressions received with cost. In some implementations, the processor can recommend the bid value from the identified bid bucket having the highest impression cost ratio as the desired bid value to the advertiser. In some implementations, the processor can receive a request from an advertiser to determine a bid value that provides the highest impression cost ratio that also results in the advertiser wins 60% of all auctions. In some implementations, the processor can then identify all bid buckets that have an impression rate above 60% and select a bid bucket from the identified bid buckets that provides the highest impression cost ratio.

Referring briefly to FIG. 2, a graphical representation of impressions to bid values is shown. This graphical representation is one way of representing a bid landscape. As shown in FIG. 2, the graphical representation plots impressions won per thousand bids placed over CPM (or bid value). As shown, at a CPM of $1, the advertiser won 100 impressions. At a CPM of $3, the advertiser won 125 impressions, at a CPM of $5, the advertiser won approximately 275 impressions and at a CPM of $6, the advertiser won approximately 300 impressions. The advertiser can use this data to determine what bid value to set for the content placement campaign to which this bid landscape corresponds. From this graph, the advertiser can determine that by increasing the CPM from $3 to $5, the advertiser is realizing an impression rate increase from 12.5% to 27.5%, which is a much greater increase than when the CPM is increased from $1 to $3 or from $5 to $8.

FIG. 3 is a screenshot of a user interface showing an impression rate over costs. The user interface 300 shows a graphical representation 302 of the impression rate over a plurality of bid buckets presented in the form of CPM. As shown, bid values after a CPM of $15.8 do not alter the win percentage significantly, whereas the greatest marginal change in win percentage occurs at lower CPMs, in particular, between 0.4 and approximately $3. The user interface 300 also allows an advertiser to select a timeframe over which to view the bid landscape. As shown, the bid landscape is viewed over an entire lifetime, which can be since the advertiser began participating in bid discovery. In this scenario, all data from content serving opportunities that participated in bid discovery is utilized. If the advertiser selected the ‘Last 3 days’ option, the data processing system 110 would generate a bid landscape using only the data from content serving opportunities that participated in bid discovery over the last 3 days.

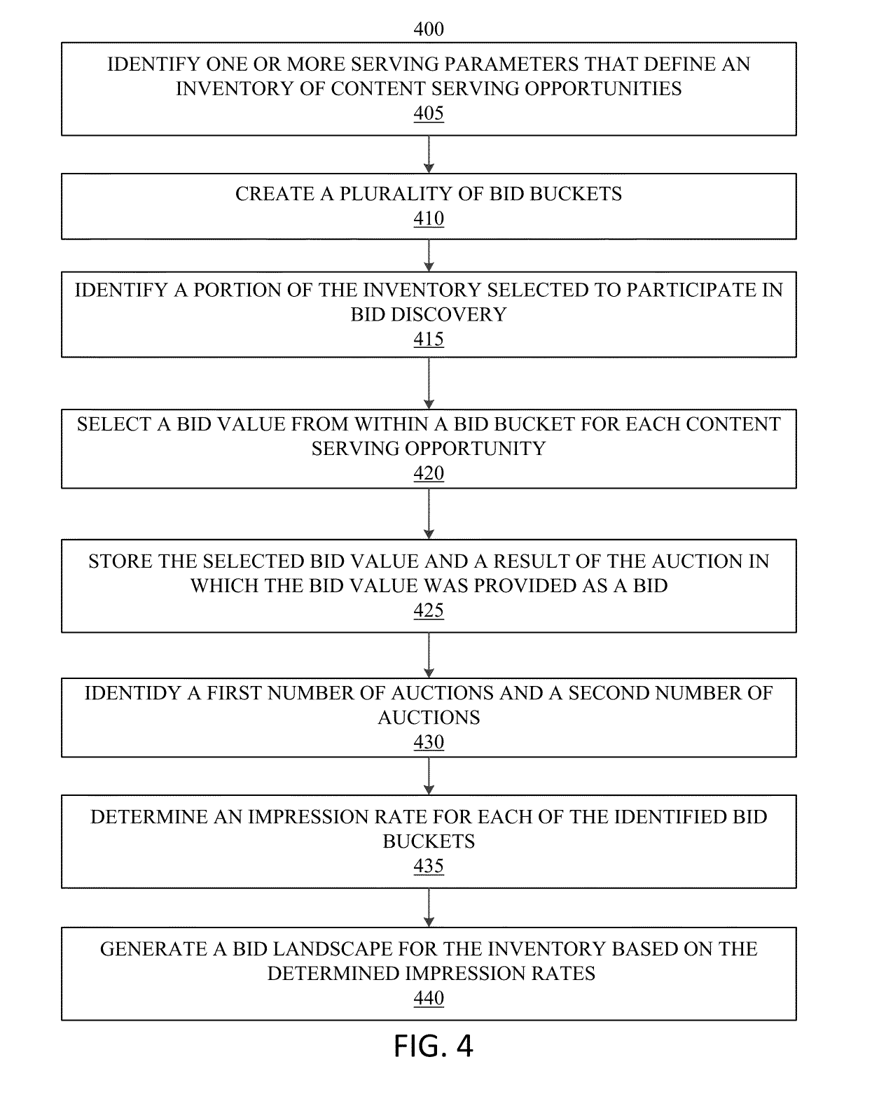

FIG. 4 is a flow diagram depicting one implementation of the steps taken to utilizing heuristic bidding to determine an inventory bid landscape of an active real-time third-party content campaign. In particular, FIG. 4 illustrates a flow diagram depicting a method 400 for determining an inventory bid landscape of a content placement campaign. In brief overview, a data processing system identifies, for a content placement provider, one or more serving parameters that define an inventory of content serving opportunities (BLOCK 405). The data processing system creates a plurality of bid buckets (BLOCK 410). Each of the bid buckets has a bid range that extends from a beginning bid boundary and an end bid boundary. The data processing system identifies a portion of the inventory of content serving opportunities to participate in bid discovery (BLOCK 415). The data processing system selects, for each content serving opportunity identified to participate in bid discovery, a bid value from within a bid bucket of the plurality of bid buckets (BLOCK 420). The selected bid value is provided as a bid for an auction to serve content in the content serving opportunity. The data processing system stores in a data store, for each of the content serving opportunities identified to participate in bid discovery, the selected bid value and a result of the auction in which the selected bid value was provided as a bid (BLOCK 425). The data processing system then identifies, from the data store, for each of the identified bid buckets, a first number of auctions in which a bid value from within a bid bucket was selected as a winning bid and a second number of auctions in which a bid value from within the bid bucket was selected to provide a bid (BLOCK 430). The data processing system then determines, from the data store, for each of the identified bid buckets, an impression rate corresponding to a ratio of the first number of auctions to the second number of auctions (BLOCK 435) and generates, from the determined impression rates, a bid landscape for the inventory based on the determined impression rates (BLOCK 440).

The data processing system identifies, for a content placement provider, one or more serving parameters that define an inventory of content serving opportunities (BLOCK 405). In some implementations, the data processing system can identify the one or more serving parameters that define an inventory of content serving opportunities by receiving the one or more serving parameters from the content placement provider. The serving parameters of the advertiser can include conditions on the types of content serving opportunities for which to place a bid in an auction to serve content. For example, if the advertiser is a tennis retailer, the advertiser can set one or more serving parameters to provide advertisements on sports related websites. The inventory of content serving opportunities includes all content serving opportunities for which the advertiser can place a bid in an auction to serve the advertiser's content.

The data processing system can create a plurality of bid buckets (BLOCK 410). Each of the bid buckets has a bid range that extends from a beginning bid boundary and an end bid boundary. In some implementations, the data processing system can create a plurality of bid buckets by determining a number of bid buckets across which to generate the bid landscape. In some implementations, each bid bucket has an associated bucket width identified as a difference between the end bid boundary and the beginning bid boundary of the associated bid bucket. In some such implementations, the bucket width of a bid bucket is a function of the bid value associated with the bid bucket.

In some implementations, the data processing system can determine a range of bid values over which to determine a bid landscape. For example, the bounds of the range of bid values can be based on a bid value specified by the advertiser. In some implementations, the bounds of the range of bid values can extend from 10% of the bid value specified by the advertiser to 16 times the bid value specified by the advertiser. In some implementations, the bounds can be based on an analysis of historical bid values for content serving opportunities that meet the serving parameters of the advertiser's content placement campaign. In some such implementations, the range of the bid values can extend from 10% of an average of the historical bid values to 16 times the average. In some implementations, a lower bound of the range of bid values can be anywhere from 1%-90% of the bid value used to calculate the range of bid values, while a higher bound of the range of bid values can be anywhere from 1.5 times to 50 times the bid value used to calculate the range of bid values.

The data processing system can then create one or more bid buckets spanning the range of bid values over which to determine a bid landscape. As described above, the range of bid values over which to determine a bid landscape can have a lower bound and an upper bound. In some implementations, the data processing system can determine a number of bid buckets to create. In some implementations, the number of bid buckets to create can be provided by the advertiser. In some implementations, the data processing system can determine a number of bid buckets across which to determine the bid landscape based on the range of bid values over which to determine a bid landscape. In some implementations, the data processing system can determine the number of bid buckets to create based on bid values of auctions previously conducted.

The data processing system can then identify a portion of the inventory of content serving opportunities for selection to participate in bid discovery (BLOCK 415). In some implementations, the advertiser can elect to participate in bid discovery. In some implementations, the advertiser can be presented with an option to have a particular content placement campaign of the advertiser participate in bid discovery. In some implementations, the advertiser can select a percentage of the inventory of content serving opportunities to use towards participating in bid discovery. For the remaining percentage of content serving opportunities, the data processing system can use a bid value provided by the advertiser to compete in auctions for serving content in content serving opportunities. For example, if the advertiser elects to use 10% of the content serving opportunities for bid discovery, the data processing system will select every tenth content serving opportunity for bid discovery. For the remaining nine content serving opportunities, the data processing system will use the bid value provided by the advertiser. In some implementations, the data processing system can automatically determine the number of content serving opportunities to use in bid discovery. In some implementations, the number of content serving opportunities can be based on a budget of the advertiser. In some implementations, the advertiser may allocate a separate budget for bid discovery. In some implementations, the advertiser may also provide a time frame within which to utilize the budget. In some implementations, the budget and the time frame can be used to determine the percentage or number of content serving opportunities to use for bid discovery.

The data processing system selects, for each content serving opportunity identified to participate in bid discovery, a bid value from within a bid bucket of the plurality of bid buckets (BLOCK 420). The selected bid value is provided as a bid for an auction to serve content in the content serving opportunity. In some implementations, the data processing system can select a bid value from within a bid bucket of the plurality of bid buckets by randomly selecting a bid value from within a bid bucket of the plurality of bid buckets. In some implementations, the data processing system can first select a bid bucket from which to choose a bid value to place a bid for a content serving opportunity. In some implementations, the bid bucket can be selected at random. In some implementations, the bid bucket can be selected according to a predetermined sequence. Factors considered when selecting a bid bucket can include time of day, device type, user information associated with the device on which the content is to be served, amongst others. In some implementations, the data processing system can select the bid bucket according to which to bid for the content serving opportunity by selecting a bid bucket using a bid selection policy that includes one or more bid selection rules. Once a bid bucket is selected, the data processing system can determine a bid value of the selected bid bucket as a bid for the identified content serving opportunity. The bid value can be the average bid value of the bid bucket. In some implementations, the average bid value can be determined by dividing the sum of the beginning bid boundary and the end bid boundary of the bid bucket by two. In some implementations, the bid value can be any bid value between the beginning bid boundary and the end bid boundary. In some implementations, the bid value can be selected at random.

The data processing system stores in a data store, for each of the content serving opportunities identified to participate in bid discovery, the selected bid value and a result of the auction in which the selected bid value was provided as a bid (BLOCK 425). In some implementations, the data processing system can maintain one or more data stores or databases that store information about the content serving opportunities identified to participate in bid discovery. In some implementations, data processing system can determine whether the selected bid was one of a winning bid or a losing bid. If the advertiser's selected bid resulted in a content item of the advertiser being served for the content serving opportunity, the data processing system can determine that the selected bid is a winning bid. Conversely, if the advertiser's selected bid does not result in a content item of the advertiser being served for the content serving opportunity, the data processing system can determined that the selected bid is a losing bid.

The data processing system then identifies, from the data store, for each of the identified bid buckets, a first number of auctions in which a bid value from within a bid bucket was selected as a winning bid and a second number of auctions in which a bid value from within the bid bucket was selected to provide a bid (BLOCK 430).

The data processing system then determines, from the data store, for each of the identified bid buckets, an impression rate corresponding to a ratio of the first number of auctions to the second number of auctions (BLOCK 435). In some implementations, the data processing system can determine an impression rate for each of the identified bid buckets. The impression rate is the percentage of auctions in which bid values from within a bid bucket cause a content item of the advertiser to achieve an impression. To determine an impression rate for a bid bucket, the data processing system can identify the total number of bid values selected from the bid bucket to be placed as bids in auctions for content serving opportunities. The data processing system can also determine a number of bid values from the total number of bid values that resulted in the advertiser serving content for the content serving opportunity. The data processing system can then divide the number of winning bid values by the total number of bid values to determine an impression rate for the given bid bucket.

The data processing system then generates, from the determined impression rates, a bid landscape for the inventory based on the determined impression rates (BLOCK 440). In some implementations, the bid landscape determination module 125 can present the impression rates of each of the bid buckets in a graphical representation.

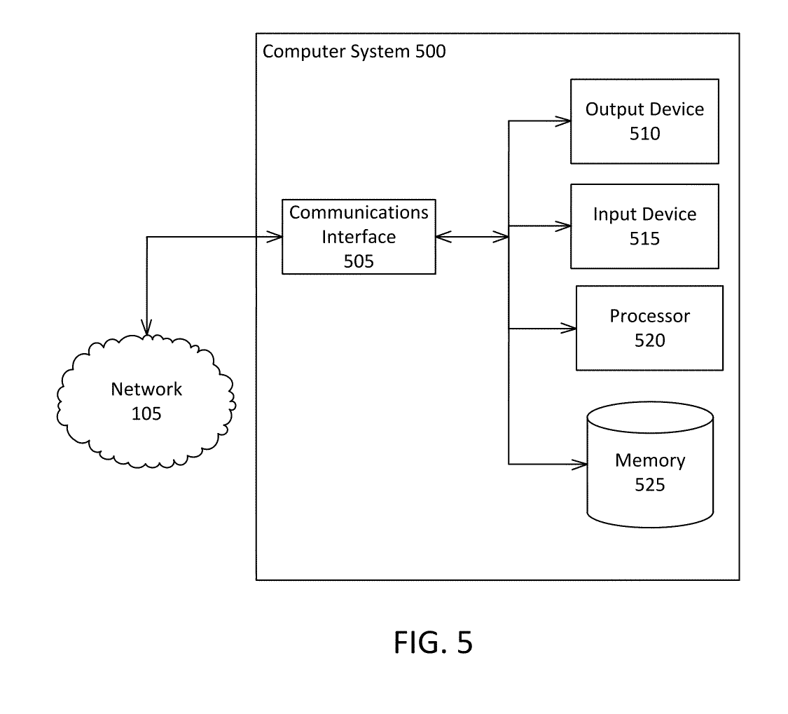

FIG. 5 shows the general architecture of an illustrative computer system 500 that may be employed to implement any of the computer systems discussed herein (including the system 100 and its components such as the bid bucket creation module 120 and the bid landscape determination module 125) in accordance with some implementations. The computer system 500 can be used to provide information via the network 105 for display. The computer system 500 of FIG. 5 comprises one or more processors 520 communicatively coupled to memory 525, one or more communications interfaces 505, and one or more output devices 510 (e.g., one or more display units) and one or more input devices 515. The processors 520 can be included in the data processing system 110 or the other components of the system 100 such as the bid bucket creation module 120 and the bid landscape determination module 125.

In the computer system 500 of FIG. 5, the memory 525 may comprise any computer-readable storage media, and may store computer instructions such as processor-executable instructions for implementing the various functionalities described herein for respective systems, as well as any data relating thereto, generated thereby, or received via the communications interface(s) or input device(s) (if present). Referring again to the system 100 of FIG. 1, the data processing system 110 can include the memory 525 to store auction related information, including bid values, bid outcomes and bid landscapes. The memory 525 can include the database 140. The processor(s) 520 shown in FIG. 5 may be used to execute instructions stored in the memory 525 and, in so doing, also may read from or write to the memory various information processed and or generated pursuant to execution of the instructions.

The processor 520 of the computer system 500 shown in FIG. 5 also may be communicatively coupled to or control the communications interface(s) 505 to transmit or receive various information pursuant to execution of instructions. For example, the communications interface(s) 505 may be coupled to a wired or wireless network, bus, or other communication means and may therefore allow the computer system 500 to transmit information to or receive information from other devices (e.g., other computer systems). While not shown explicitly in the system of FIG. 1, one or more communications interfaces facilitate information flow between the components of the system 100. In some implementations, the communications interface(s) may be configured (e.g., via various hardware components or software components) to provide a website as an access portal to at least some aspects of the computer system 500. Examples of communications interfaces 505 include user interfaces (e.g., web pages), through which the user can communicate with the data processing system 110.

The output devices 510 of the computer system 500 shown in FIG. 5 may be provided, for example, to allow various information to be viewed or otherwise perceived in connection with execution of the instructions. The input device(s) 515 may be provided, for example, to allow a user to make manual adjustments, make selections, enter data, or interact in any of a variety of manners with the processor during execution of the instructions. Additional information relating to a general computer system architecture that may be employed for various systems discussed herein is provided further herein.

Implementations of the subject matter and the operations described in this specification can be implemented in digital electronic circuitry, or in computer software embodied on a tangible medium, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on computer storage medium for execution by, or to control the operation of, data processing apparatus. The program instructions can be encoded on an artificially-generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The features disclosed herein may be implemented on a smart television module (or connected television module, hybrid television module, etc.), which may include a processing module configured to integrate internet connectivity with more traditional television programming sources (e.g., received via cable, satellite, over-the-air, or other signals). The smart television module may be physically incorporated into a television set or may include a separate device such as a set-top box, Blu-ray or other digital media player, game console, hotel television system, and other companion device. A smart television module may be configured to allow viewers to search and find videos, movies, photos and other content on the web, on a local cable TV channel, on a satellite TV channel, or stored on a local hard drive. A set-top box (STB) or set-top unit (STU) may include an information appliance device that may contain a tuner and connect to a television set and an external source of signal, turning the signal into content which is then displayed on the television screen or other display device. A smart television module may be configured to provide a home screen or top level screen including icons for a plurality of different applications, such as a web browser and a plurality of streaming media services, a connected cable or satellite media source, other web “channels”, etc. The smart television module may further be configured to provide an electronic programming guide to the user. A companion application to the smart television module may be operable on a mobile computing device to provide additional information about available programs to a user, to allow the user to control the smart television module, etc. In alternate implementations, the features may be implemented on a laptop computer or other personal computer, a smartphone, other mobile phone, handheld computer, a tablet PC, or other computing device.

The operations described in this specification can be implemented as operations performed by a data processing apparatus on data stored on one or more computer-readable storage devices or received from other sources.

The terms “data processing apparatus”, “data processing system”, “user device” or “computing device” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures. The bid bucket creation module 120 and the bid landscape determination module 125 can include or share one or more data processing apparatuses, computing devices, or processors.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatuses can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), for example. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube), plasma, or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system such as system 500 or system 100 can include clients and servers. For example, the data processing system 110 can include one or more servers in one or more data centers or server farms. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular implementations of the systems and methods described herein. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In some cases, the actions recited in the claims can be performed in a different order and still achieve desirable results. In addition, the processes depicted in the accompanying figures do not necessarily require the particular order shown, or sequential order, to achieve desirable results.

In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. For example, the bid bucket creation module 120 and the bid landscape determination module 125 can be part of the data processing system 110, a single module, a logic device having one or more processing modules, one or more servers, or part of a search engine.

Having now described some illustrative implementations and implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed only in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation, and references to “an implementation,” “some implementations,” “an alternate implementation,” “various implementation,” “one implementation” or the like are not necessarily mutually exclusive and are intended to indicate that a particular feature, structure, or characteristic described in connection with the implementation may be included in at least one implementation. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms.

Where technical features in the drawings, detailed description or any claim are followed by reference signs, the reference signs have been included for the sole purpose of increasing the intelligibility of the drawings, detailed description, and claims. Accordingly, neither the reference signs nor their absence have any limiting effect on the scope of any claim elements.

The systems and methods described herein may be embodied in other specific forms without departing from the characteristics thereof Although the examples provided herein relate to an advertising program, the systems and methods described herein can be applied to any program in any vertical in which heuristic bidding is used to generate a bid landscape. The foregoing implementations are illustrative rather than limiting of the described systems and methods. Scope of the systems and methods described herein is thus indicated by the appended claims, rather than the foregoing description, and changes that come within the meaning and range of equivalency of the claims are embraced therein.

What is claimed is:

1. A method for determining a bid landscape for a content placement campaign, comprising:
identifying, by a processor, for a content placement provider, one or more serving parameters that define an inventory of content serving opportunities;
creating, by the processor, a plurality of bid buckets, each of the bid buckets has a bid range extending between a beginning bid boundary and an end bid boundary;
identifying, by the processor, a portion of the inventory of content serving opportunities to participate in bid discovery;
selecting, by the processor, for each content serving opportunity identified to participate in bid discovery, a bid value from within a bid bucket of the plurality of bid buckets, the selected bid value provided as a bid for an auction to serve content in the content serving opportunity;
storing, for each of the content serving opportunities identified to participate in bid discovery, in a data store, the selected bid value and a result of the auction in which the selected bid value was provided as a bid;
identifying, from the data store, for each of the identified bid buckets, a first number of auctions in which a bid value from within a bid bucket was selected as a winning bid and a second number of auctions in which a bid value from within the bid bucket was selected to provide a bid;
determining, from the data store, for each of the identified bid buckets, an impression rate corresponding to a ratio of the first number of auctions to the second number of auctions; and
generating, from the determined impression rates, a bid landscape for the inventory based on the determined impression rates.

2. The method of claim 1, wherein selecting a bid value from within a bid bucket of the plurality of bid buckets includes randomly selecting a bid value from within a bid bucket of the plurality of bid buckets.

3. The method of claim 1, wherein creating a plurality of bid buckets comprising determining a number of bid buckets across which to generate the bid landscape.

4. The method of claim 1, wherein creating a plurality of bid buckets includes:
determining a maximum bid value for placing as a bid in bid discovery;
determining a number of bid buckets across which to generate the bid landscape; and
determining a bid range for each of the bid buckets.

5. The method of claim 1, wherein each bid bucket having an associated bucket width identified as a difference between the end bid boundary and the beginning bid boundary of the associated bid bucket, the bucket width of a bid bucket is a function of a bid value of with the bid bucket.

6. The method of claim 1, further comprising:
receiving, for the content placement provider, a request to participate in an auction to serve content in a content serving opportunity;
determining that the content serving opportunity of the request matches the serving parameters of the content placement provider;
determining that the content serving opportunity of the request is a content serving opportunity identified to participate in bid discovery;
selecting, from the plurality of bid buckets, a bid bucket according to which to bid for the content serving opportunity;
providing, in the auction to serve content, a bid value from within the selected bid bucket as a bid for the content serving opportunity;
determining that the bid was one of a winning bid or a losing bid;
increasing a winning bid counter of the selected bid bucket responsive to determining that the bid was a winning bid;
increasing a total bid counter of the selected bid bucket responsive to determining that the bid was one of a winning bid or a losing bid; and
updating an impression conversion rate of the selected bid bucket.

7. The method of claim 6, wherein selecting, from the plurality of bid buckets, a bid bucket according to which to bid for the content serving opportunity includes selecting a bid bucket using a bid selection policy that includes one or more bid selection rules, the bid selection rules are based on one or more of impression-specific data or a total bid counter of the selected bid bucket identifying a total number of bids placed at the associated bid value of the selected bid bucket.

8. The method of claim 1, further comprising:
determining, from the determined impression rates, a marginal change in impression rates for each of the plurality of bid buckets, the marginal change in impression rates identifying a difference in an impression rate of a subject bid bucket having an average bid value and an adjacent bid bucket having an average bid value that is smaller than the average bid value of the subject bid bucket;
determining, from the associated bid values of the plurality of bid buckets, a marginal change in bid values for each of the plurality of bid buckets, the marginal change in bid values identifying a difference in a bid value of the subject bid bucket and the average bid value of the adjacent bid bucket;
determining, for each bid bucket, an impression cost ratio corresponding to a ratio of the determined marginal change in impression rates to the determined marginal change in bid values;
identifying the bid bucket having the highest impression cost ratio; and
setting a bid value from within the identified bid bucket having the highest impression cost ratio as the desired bid value for balancing impressions received with cost.

9. A system for determining a bid landscape for a content placement campaign, comprising:
a data processing system having a bid bucket creation module and a bid landscape determination module, the data processing system further comprising
a memory storing processor-executable instructions; and
a processor configured to execute the processor-executable instructions to:
identify, for a content placement provider, one or more serving parameters that define an inventory of content serving opportunities;
create a plurality of bid buckets, each of the bid buckets has a bid range extending between a beginning bid boundary and an end bid boundary;
identify a portion of the inventory of content serving opportunities for selection to participate in bid discovery;
select, for each content serving opportunity identified to participate in bid discovery, a bid value from within a bid bucket of the plurality of bid buckets, the selected bid value provided as a bid for an auction to serve content in the content serving opportunity;
store, for each of the content serving opportunities identified to participate in bid discovery, in a data store, the selected bid value and a result of the auction in which the selected bid value was provided as a bid;
identify, from the data store, for each of the identified bid buckets, a first number of auctions in which a bid value from within a bid bucket was selected as a winning bid and a second number of auctions in which a bid value from within the bid bucket was selected to provide a bid;
determine, from the data store, for each of the identified bid buckets, an impression rate corresponding to a ratio of the first number of auctions to the second number of auctions; and
generate, from the determined impression rates, a bid landscape for the inventory based on the determined impression rates.

10. The system of claim 9, wherein to identify, for a content placement provider, one or more serving parameters that define an inventory of content serving opportunities comprises receiving the one or more serving parameters from the content placement provider.

11. The system of claim 9, wherein to create a plurality of bid buckets comprises determining a number of bid buckets across which to generate the bid landscape.

12. The system of claim 9, wherein each bid bucket having an associated bucket width identified as a difference between the end bid boundary and the beginning bid boundary of the associated bid bucket, the bucket width of a bid bucket is a function of the bid value associated with the bid bucket.

13. The system of claim 9, wherein the data processing system is further configured to:
identify a content serving opportunity for selection to participate in bid discovery;
select, from the plurality of bid buckets, a bid bucket according to which to bid for the content serving opportunity;
place, in an auction to serve content, a bid value of the selected bid bucket as a bid for the identified opportunity;
determine that the bid was one of a winning bid or a losing bid;
increase a winning bid counter of the selected bid bucket responsive to determining that the bid was a winning bid;
increase a total bid counter of the selected bid bucket responsive to determining that the bid was one of a winning bid or a losing bid; and
update an impression conversion rate of the selected bid bucket.

14. The system of claim 13 wherein to select, from the plurality of bid buckets, a bid bucket according to which to bid for the content serving opportunity includes selecting a bid bucket using a bid selection policy that includes one or more bid selection rules, the bid selection rules are based on one or more of impression-specific data or a total bid counter of the selected bid bucket identifying a total number of bids placed from within the selected bid bucket.

15. The system of claim 9, wherein the data processing system is further configured to:
determine, from the determined impression rates, a marginal change in impression rates for each of the plurality of bid buckets, the marginal change identifying a difference in an impression rate of a subject bid bucket having an average bid value and an adjacent bid bucket having an average bid value that is smaller than the average bid value of the subject bid bucket;
determine, from bid values of a plurality of bid buckets, a marginal change in bid values for each of the plurality of bid buckets, the marginal change identifying a difference in a bid value of the subject bid bucket and an average bid value of the adjacent bid bucket;
determine, for each bid bucket, an impression cost ratio corresponding to a ratio of the determined marginal change in impression rates to the determined marginal change in bid values;
identify the bid bucket having the highest impression cost ratio; and
set a bid value from within the identified bid bucket having the highest impression cost ratio as the desired bid value for balancing impressions received with cost.

16. A computer-readable storage medium having instructions to provide information via a computer network, the instructions comprising instructions to:
identify, for a content placement provider, one or more serving parameters that define an inventory of content serving opportunities;
create a plurality of bid buckets, each of the bid buckets has a bid range extending between a beginning bid boundary and an end bid boundary;
identify a portion of the inventory of content serving opportunities for selection to participate in bid discovery;
select, for each content serving opportunity identified to participate in bid discovery, a bid value from within a bid bucket of the plurality of bid buckets, the selected bid value provided as a bid for an auction to serve content in the content serving opportunity;
store, for each of the content serving opportunities identified to participate in bid discovery, in a data store, the selected bid value and a result of the auction in which the selected bid value was provided as a bid;
identify, from the data store, for each of the identified bid buckets, a first number of auctions in which a bid value from within a bid bucket was selected as a winning bid and a second number of auctions in which a bid value from within the bid bucket was selected to provide a bid;
determine, from the data store, for each of the identified bid buckets, an impression rate corresponding to a ratio of the first number of auctions to the second number of auctions; and
generate, from the determined impression rates, a bid landscape for the inventory based on the determined impression rates.

17. The computer readable storage medium of claim 16, wherein to identify, for a content placement provider, one or more serving parameters that define an inventory of content serving opportunities comprises receiving the one or more serving parameters from the content placement provider.

18. The computer readable storage medium of claim 16, wherein each bid bucket has an associated bucket width identified as a difference between the end bid boundary and the beginning bid boundary of the associated bid bucket, the bucket width of a bid bucket is a function of the bid value associated with the bid bucket.

19. The computer readable storage medium of claim 16, having further instructions to:
identify a content serving opportunity for selection to participate in bid discovery;
select, from the plurality of bid buckets, a bid bucket according to which to bid for the content serving opportunity;
place, in an auction to serve content, a bid value of the selected bid bucket as a bid for the identified opportunity;
determine that the bid was one of a winning bid or a losing bid;
increase a winning bid counter of the selected bid bucket responsive to determining that the bid was a winning bid;
increase a total bid counter of the selected bid bucket responsive to determining that the bid was one of a winning bid or a losing bid; and
update an impression conversion rate of the selected bid bucket.

20. The computer readable storage medium of claim 19, wherein to select, from the plurality of bid buckets, a bid bucket according to which to bid for the content serving opportunity includes selecting a bid bucket using a bid selection policy that includes one or more bid selection rules, the bid selection rules are based on one or more of impression-specific data or a total bid counter of the selected bid bucket identifying a total number of bids placed from within the selected bid bucket.
